(19) United States
(12) Patent Application Publication
(10) Pub. No.: US 2011/0009258 A1
(43) Pub. Date: Jan. 13, 2011

(54) Titanate Nanostructure and Method for Preparation Thereof

(75) Inventors: Jeung-Ku Kang, Daejeon (KR); Jung-Woo Lee, Daejeon (KR); Kyu-Sung Han, Daejeon (KR); Yeob Lee, Daejeon (KR); Dong-Ki Lee, Daejeon (KR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Korea Advanced Institute of Science and Technology, Daejeon (KR)

(21) Appl. No.: 12/556,188

(22) Filed: Sep. 9, 2009

(30) Foreign Application Priority Data
Jul. 8, 2009 (KR) 1020090062279

(51) Int. Cl. B01J 20/04

(52) U.S. Cl. 502/400

(57) ABSTRACT

Disclosed is a titanate nanostructure, especially, represented by a chemical formula of NaKTi₃O₇. A method for preparation of a titanate nanostructure is also provided. The method includes mixing titanium dioxide powder with an alkaline solution to prepare a titanium dioxide solution; and carrying out hydrothermal synthesis of the prepared titanium dioxide solution at a temperature of 120° C. to 180° C. for 12 to 72 hours.

### CROSS-REFERENCE TO RELATED APPLICATIONS

This application claims priority to foreign Patent Application KR 10-2009-0062279 filed in Korea on Jul. 8, 2009, the disclosure of which is incorporated herein by reference in its entirety.

### FIELD OF THE INVENTION

The present invention relates to a titanate nanostructure and a method for preparation of the same. Such titanate nanostructure has a large hydrogen uptake capacity, thereby being efficiently used in manufacturing a high capacity hydrogen storage medium.

### BACKGROUND OF THE RELATED ART

Fossil fuels such as petroleum, coal, natural gas, etc. currently occupy about 90% of total energy consumption. Such fossil fuels cannot be recycled after use and, if being consumed at the present rate, fossil fuel deposits may be almost exhausted in not more than 50 to 100 years. Also, various pollutants generated during combustion of fossil fuels significantly cause environmental problems such as global warming, thinness of ozone layer, acid rain, etc., threatening human life. Therefore, there is a requirement for developing non-exhaustible, clean and safe alternative energies and, ultimately, a novel energy system independent of fossil fuels such as petroleum is strongly required.

Hydrogen energy attracts the most attention as an alternative energy and a fuel cell system using hydrogen energy has merits of infinitely generating hydrogen from water without concern about a drain of resources. In addition, a fuel cell using hydrogen energy is advantageous in not exhausting environmental pollutants such as carbon dioxide CO₂.

However, such fuel cell system demands a hydrogen storage medium to use hydrogen. The Department of Energy (DOE) of the United States has proposed a specific standard applicable to utilization of substances adapted for hydrogen storage media. More particularly, the substances useful for hydrogen storage media may include materials having increased specific surface area such as, for example, carbon nanotubes, inorganic framework structure materials, metal hydrogen compounds, inorganic porous materials, metal-organic frameworks, and the like. In order to fabricate the high capacity hydrogen storage medium, different proposals such as doping of transitional metals on the medium and/or adsorption and desorption of hydrogen through phase change of metal hydrides have been suggested. However, owing to some problems including low hydrogen uptake energy and/or irreversible properties, it is difficult to produce improved hydrogen storage media with high capacity satisfying the standards proposed by the DOE.

### SUMMARY OF THE INVENTION

Accordingly, it is an object of the present invention to provide a titanate nanostructure useful for fabricating a high capacity hydrogen storage medium and a method for preparation thereof.

In order to achieve the above object, the present invention provides a titanate nanostructure represented by a chemical formula of AaBbTixOy wherein A and B are alkaline metals and 0≦a≦9, 0≦b≦9, 1≦a+b≦18, 1≦x≦10 and 2≦y≦20 with a, b, x and y each being an integer.

In order to achieve the above object, the present invention also provides a method for preparation of a titanate nanostructure comprising preparing a titanium dioxide solution by mixing titanium dioxide powder with alkaline solutions and carrying out hydrothermal synthesis of the prepared titanium dioxide solution at a temperature of 120 to 180 for 12 to 72 hours.

The titanate nanostructure of the present invention has enhanced hydrogen uptake capacity, thus being effectively used in fabricating high capacity hydrogen storage media of fuel cells.

The method for preparation of the titanate nanostructure using hydrothermal synthesis according to the present invention may control a length, a diameter and/or interlayer characteristics of the titanate nanostructure by regulating the alkaline solution, so as to improve hydrogen uptake capacity of the nanostructure.

### BRIEF DESCRIPTION OF THE DRAWINGS

These and other objects, features, aspects, and advantages of the present invention will be more fully described in the following detailed description of examples, taken in conjunction with the accompanying drawings. In the drawings:

FIG. 1A is a TEM photograph illustrating a titanate nanostructure prepared according to Preparative Example 1 and FIG. 1B is an enlarged TEM photograph of the same;

FIG. 2A is a TEM photograph illustrating a titanate nanostructure prepared according to Preparative Example 2 and FIG. 2B is an enlarged TEM photograph of the same;

FIG. 3 is a TEM photograph illustrating a titanate nanostructure prepared according to Preparative Example 3;

FIG. 4 is a graph showing XRD analysis results of the titanate nanostructure prepared according to Preparative Example 3;

FIG. 5 is a graph showing Brunauer-Emmett-Teller (BET) analysis results of the titanate nanostructures prepared according to Preparative Examples 1 and 3;

FIG. 6 is a graph showing measured results of hydrogen uptake capacities of the titanate nanostructures prepared according to Preparative Examples 1 and 3; and

FIG. 7 is a graph showing Pressure-Component-Temperature (P-C-T) results of the titanate nanostructures prepared according to Preparative Examples 1 and 3.

### DETAILED DESCRIPTION

The present invention describes a titanate nanostructure and a method for preparation of the same.

The titanate nanostructure is represented by a chemical formula of AaBbTixOy wherein A and B are alkaline metals and 0≦a≦9, 0≦b≦9, 1≦a+b≦18, 1≦x≦10 and 2≦y≦20 with a, b, x and y each being an integer. b is not 0 with a=0 while a is not 0 with b=0, therefore, a+b is always at least 1.

The method for preparation of the titanate nanostructure comprises mixing titanium dioxide powder with alkaline solutions to prepare a titanium dioxide solution and hydrothermally synthesizing the prepared titanium dioxide solution at a temperature of 120 to 180 for 12 to 72 hours.

The nanostructure may include nanotubes or nanowires.

The titanate nanostructure may have a specific crystal structure selected from a group consisting of anatase, rutile and brookite.

The alkaline solution may comprise at least one selected from a group consisting of NaOH, KOH, LiOH, Ca(OH)₂ and Mg(OH)₂ or mixtures thereof. The alkaline solution may have a concentration ranging from 1M to 15M. Regulating the alkaline solution may control a length, a diameter and/or interlayer characteristics of the titanate nanostructure.

Hereinafter, the present invention will be described in greater detail with reference to the following preparative examples, experimental examples and comparative examples. However, these examples are intended for illustrative purposes and it would be appreciated by a person skilled in the art that various modifications and variations may be made without departing from the scope of the present invention. Therefore, it is not construed that the present invention is restricted to such examples.

### EXAMPLES

### Preparative Example 1: Titanate Nanostructure Prepared Using 10M NaOH

Mixing 1 g of titanium dioxide powder having an anatase crystal structure with 100 mL of 10M NaOH, a titanium dioxide solution was prepared. Then, the titanium dioxide solution was put in a Teflon liner and fully agitated at room temperature for 12 hours. Next, the fully agitated titanium dioxide solution was placed in an autoclave and was subjected to hydrothermal synthesis at a temperature of 140 for 72 hours, so as to complete a titanate nanostructure.

In order to separate the obtained titanate nanostructure, the following processes were performed.

The titanium dioxide solution after hydrothermal synthesis was cooled at room temperature, followed by centrifuging at 5,000 rpm for 10 minutes and washing the solution. Then, adding 1M HCl to the washed titanium dioxide solution neutralized the titanium dioxide solution to pH 7. Drying the solution at 60 for 8 hours, a titanate nanostructure Na₂Ti₃O₇ in a powder form was obtained.

### Preparative Example 2: Titanate Nanostructure Prepared Using 10M KOH

A titanate nanostructure was prepared by the same procedure as described in Preparative Example 1, except that 100 mL of 10M NaOH was replaced by 100 mL of 10M KOH. As a result, the titanate nanostructure K₂Ti₃O₇ in a powder form was obtained.

### Preparative Example 3: Titanate Nanostructure Prepared Using Mixture of 10M NaOH and 10M KOH

A titanate nanostructure was prepared by the same procedure as described in Preparative Example 1, except that 100 mL of 10M NaOH was replaced by 100 mL of mixed solution including 10M NaOH and 10M KOH.

The mixed solution of 10M NaOH and 10M KOH was prepared by introducing 50 mL of 10M NaOH and 50 mL of 10M KOH into a Teflon liner and blending and fully agitating the mixture. As a result, the titanate nanostructure NaKTi₃O₇ in a powder form was obtained.

### Experimental Example 1: TEM Analysis

In order to investigate forms of the titanate nanostructures prepared according to the foregoing preparative examples 1 to 3, a TEM analysis was performed.

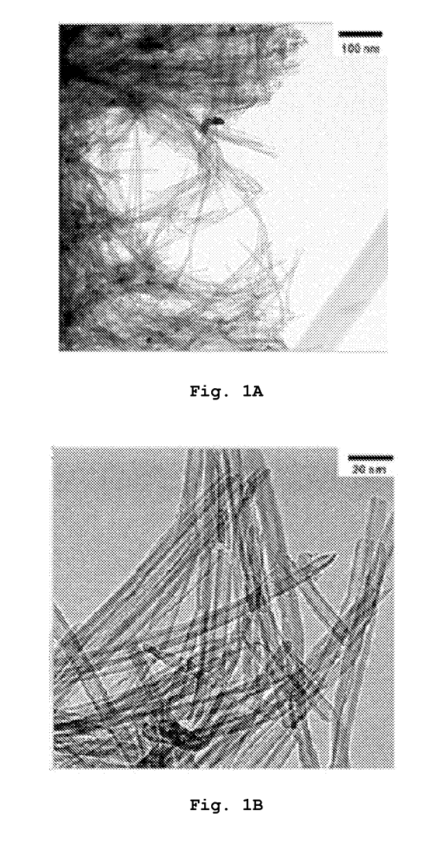

FIG. 1A is a TEM photograph and FIG. 1B is an enlarged TEM photograph illustrating the titanate nanostructure prepared according to Preparative Example 1.

As shown in FIG. 1A, the titanate nanostructure in Preparative Example 1 was nanotube and was aggregated in a spherical bundle form. Each of the nanotubes had a length of about 500 nm. As shown in FIG. 1B, a plurality of nanotubes having a diameter of about 5 nm were overlapped into 3 to 4 layers.

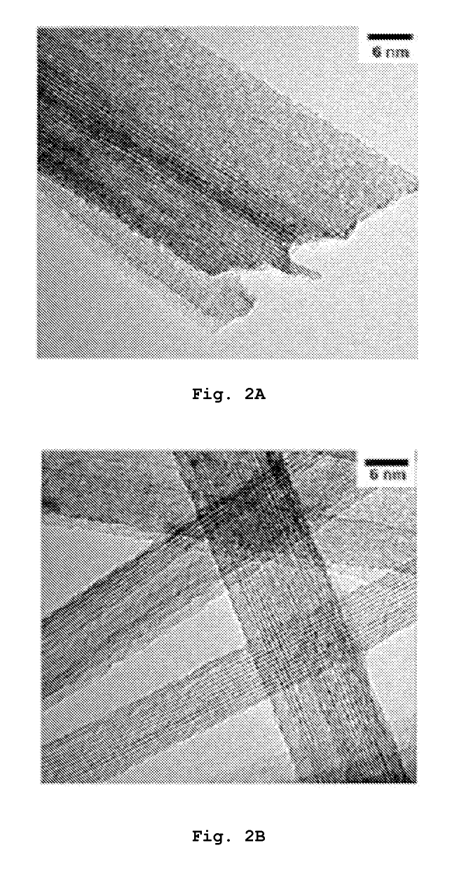

FIG. 2A is a TEM photograph and FIG. 2B is an enlarged TEM photograph illustrating the titanate nanostructure prepared according to Preparative Example 2. As shown in FIG. 2A, the titanate nanostructure in Preparative Example 2 was nanowire and each of the nanowires had a diameter of about 7 nm and a length of several μm. As shown in FIG. 2B, a plurality of nanowires were overlapped into 10 to 30 layers.

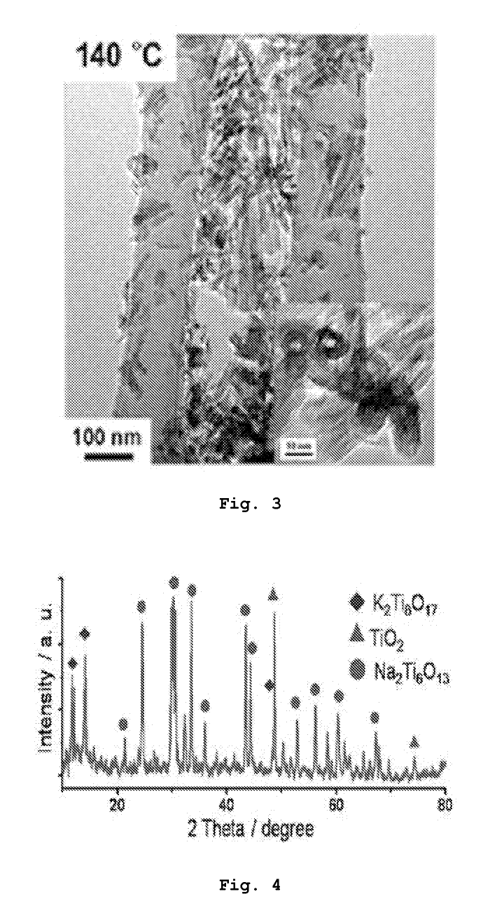

FIG. 3 is a TEM photograph and an enlarged TEM photograph illustrating the titanate nanostructure prepared according to Preparative Example 3. As shown in FIG. 3, multiple nanotubes were aggregated into a bundle form and each of the nanotubes had a diameter of about 5 nm and a length of several tens of nm.

As shown in the FIG. 1A to FIG. 3, the inventive method for preparation of a titanate nanostructure may regulate the alkaline solution so as to control a shape and a length of the titanate nanostructure, as well as the number of overlapped layers of the titanate nanostructures.

### Experimental Example 2: XRD Analysis

In order to analyze the titanate nanostructure NaKTi₃O₇ prepared according to Preparative Example 3, an XRD analysis was performed as shown in FIG. 4.

From results of the XRD analysis shown in FIG. 4, it can be seen that the titanate nanostructure has all of three phases such as K₂Ti₈O₁₇, Na₂Ti₆O₁₃ and TiO₂. This result demonstrates that different alkaline metals, that is, sodium Na and potassium K co-exist between titanate nanostructure layers.

### Experimental Example 3: BET Analysis

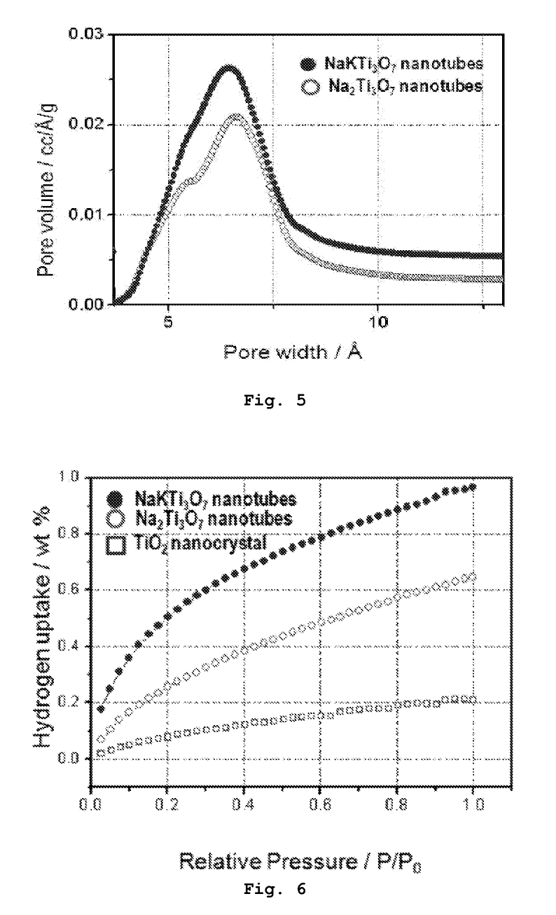

In order to analyze a volume of micropores in each of the titanate nanostructures prepared according to Preparative Examples 1 and 3 by Horvath-Kawazoe (HK) process, a Brunauer-Emmett-Teller (BET) analysis was performed and results thereof are shown in FIG. 5. Referring to FIG. 5, a graph for Na₂Ti₃O₇ nanotubes demonstrates the titanate nanostructure in Preparative Example 1 while a graph for NaKTi₃O₇ nanotubes demonstrates the titanate nanostructure in Preparative Example 3.

As shown in FIG. 5, if a pore width is about 6, the micropore volume of the titanate nanostructure (NaKTi₃O₇ nanotubes) in Preparative Example 3 was larger than that of the titanate nanostructure (Na₂Ti₃O₇ nanotubes) in Preparative Example 1. The reason for such results is presumed that the titanate nanostructure in Preparative Example 3 has a length shorter than that of the titanate nanostructure in Preparative Example 1, thus exhibiting relatively large surface area.

### Comparative Example 1: Hydrogen Uptake Capacity

For the titanate nanostructures prepared according to Preparative Examples 1 and 3, the hydrogen uptake capacity was determined while varying relative pressure in the range of 0 to 1 atm. The measured results are shown in FIG. 6. Here, a temperature was fixed to 77K. Referring to FIG. 6, a graph for Na₂Ti₃O₇ nanotubes demonstrates the titanate nanostructure in Preparative Example 1 while a graph for NaKTi₃O₇ nanotubes demonstrates the titanate nanostructure in Preparative Example 3. Alternatively, titanium dioxide powder without any additional treatment was used as a control and a hydrogen uptake capacity of the control was measured. The control is represented by TiO₂ nanocrystal in FIG. 6.

Both of the titanate nanostructure (Na₂Ti₃O₇ nanotubes) in Preparative Example 1 and the titanate nanostructure (NaKTi₃O₇ nanotubes) in Preparative Example 3 exhibited considerably enhanced hydrogen uptake capacity, compared to the control (TiO₂ nanocrystal). Especially, the hydrogen uptake capacity of the titanate nanostructure (NaKTi₃O₇ nanotubes) in Preparative Example 3 reached up to about 1.0 wt. % at 1 atm (P/P₀).

Accordingly, it is understood that the titanate nanostructure of the present invention may be effectively used in manufacturing high capacity hydrogen storage media for fuel cells.

### Comparative Example 2: P-C-T Measurement

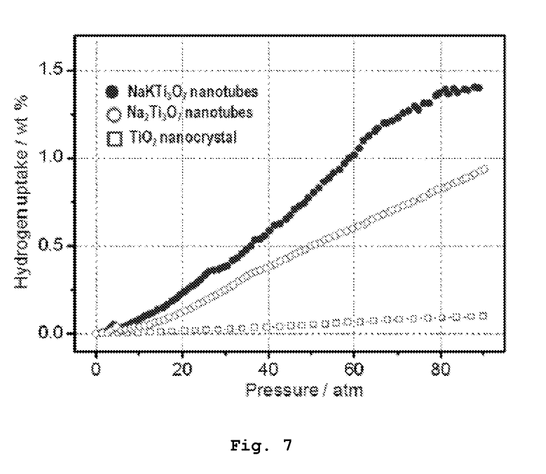

For the titanate nanostructures prepared according to Preparative Examples 1 and 3, the hydrogen uptake capacity was determined while varying pressure in the range of 0 to 90 atm. Pressure-Component-Temperature (P-C-T) results thereof are shown in FIG. 7. Here, a temperature was fixed to room temperature (25).

Referring to FIG. 7, a graph for Na₂Ti₃O₇ nanotubes demonstrates the titanate nanostructure in Preparative Example 1 while a graph for NaKTi₃O₇ nanotubes demonstrates the titanate nanostructure in Preparative Example 3. Alternatively, titanium dioxide powder without any additional treatment was used as a control and a hydrogen uptake capacity of the control was measured. The control is represented by TiO₂ nanocrystal in FIG. 7.

Both of the titanate nanostructure (Na₂Ti₃O₇ nanotubes) in Preparative Example 1 and the titanate nanostructure (NaKTi₃O₇ nanotubes) in Preparative Example 3 exhibited considerably enhanced hydrogen uptake capacity, compared to the control (TiO₂ crystal). Especially, the hydrogen uptake capacity of the titanate nanostructure (NaKTi₃O₇ nanotubes) in Preparative Example 3 reached up to about 1.4 wt. % at 90 atm.

Accordingly, it is understood that the titanate nanostructure of the present invention may be effectively used in manufacturing high capacity hydrogen storage media for fuel cells.

As is apparent from the above description, the method for preparation of a titanate nanostructure according to the present invention may control a length of the titanate nanostructure and/or interlayer characteristics thereof Consequently, shortening the length of the nanostructure while widening an interlayer distance may enable hydrogen molecules to easily penetrate between walls of the titanate nanostructure, thereby preferably improving the hydrogen uptake capacity thereof.

Therefore, a titanate nanostructure with enhanced hydrogen uptake capacity may be prepared by the method for preparation of the titanate nanostructure according to the present invention. Such a titanate nanostructure may be applied to a hydrogen storage medium of a fuel cell for a portable device. Furthermore, controlling conditions for hydrothermal synthesis may generate a variety of ion-exchange reactions so as to control band-gap energy of the titanate nanostructure according to the present invention. Accordingly, the inventive titanate nanostructure may be further applied to scientific materials such as solar cells.

Although the present invention has been described in detail with reference to its presently preferred embodiment, it will be understood by those skilled in the art that various modifications and equivalents can be made without departing from the spirit and scope of the present invention, as set forth in the appended claims. Also, the substances of each constituent explained in the specification can be easily selected and processed by those skilled in the art from the well-known various substances. Also, those skilled in the art can remove a part of the constituents as described in the specification without deterioration of performance or can add constituents for improving the performance. Furthermore, those skilled in the art can change the order to methodic steps explained in the specification according to environments of processes or equipments. Thus, it is intended that the present invention covers the modifications and variations of this invention provided they come within the scope of the appended claims and their equivalents.

1. A titanate nanostructure represented by a chemical formula of NaKTi₃O₇.

2. A method for preparation of a titanate nanostructure of NaKTi₃O₇, the method comprising:
mixing titanium dioxide powder with NaOH and KOH as an alkaline solution to prepare a titanium dioxide solution; and
carrying out hydrothermal synthesis of the prepared titanium dioxide solution at a temperature of 120 degrees Celsius to 180 degrees Celsius for 12 to 72 hours.

3. The method according to claim 2, wherein the titanium dioxide powder has a crystal structure selected from a group consisting of anatase, rutile and brookite.

4-5. (canceled)
